(19) United States
(12) Patent Application Publication
(10) Pub. No.: US 2024/0249397 A1
(43) Pub. Date: Jul. 25, 2024

(54) IMAGE PROCESSING METHOD AND APPARATUS, AND ELECTRONIC DEVICE AND READABLE STORAGE MEDIUM

(71) Applicant: Beijing Zitiao Network Technology Co., Ltd., Beijing (CN)

(72) Inventors: Siyu HE, Beijing (CN); Zhiwei LI, Beijing (CN)

(21) Appl. No.: 18/693,413

(22) PCT Filed: Oct. 8, 2022
(86) PCT No.: PCT/CN2022/123837

§ 371 Date: Mar. 19, 2024

(30) Foreign Application Priority Data
Oct. 14, 2021 (CN) 202111206046.5

(51) Int. Cl. G06T 5/70; G06T 5/20

(52) U.S. Cl. CPC G06T 5/70; G06T 5/20

(57) ABSTRACT

An image processing method, an image processing apparatus, an electronic device, and a computer-readable storage medium are provided. In the method, an image to be processed containing jaggies is acquired, and perform a one-dimensional blur processing on the image to be processed in a target direction.

The present disclosure claims the priority of Chinese Patent Application No. 202111206046.5 filed on Oct. 14, 2021, entitled “IMAGE PROCESSING METHOD AND APPARATUS, AND ELECTRONIC DEVICE AND READABLE STORAGE MEDIUM”, which is herein incorporated by reference in its entirety.

### TECHNICAL FIELD

The present disclosure relates to the field of Internet technology, in particular to an image processing method, an image processing apparatus, an electronic device, and a computer-readable storage medium.

### BACKGROUND

With the continuous development of the Internet technology, the user often chooses to process a video or a photo through an application to acquire a richer visual effect. However, an image jaggedness may exist in a processed image, so how to solve the jaggedness in the image is an urgent problem to be solved.

### SUMMARY

In order to solve or at least partially solve the above technical problems, the present disclosure provides an image processing method, an image processing apparatus, an electronic device, and a computer-readable storage medium.

In a first aspect, the present disclosure provides an image processing method, including:

acquiring an image to be processed, the image to be processed including jaggies; and

performing a one-dimensional blur processing on the image to be processed in a target direction to acquire a target image, the target direction having an association relationship with a shape of the jaggies.

In a second aspect, the present disclosure provides an image processing apparatus, including:

an acquiring module configured to acquire an image to be processed, the image to be processed including jaggies; and

a processing module configured to perform a one-dimensional blur processing on the image to be processed in a target direction to acquire a target image, the target direction having an association relationship with a shape of the jaggies.

In a third aspect, the present disclosure provides an electronic device, including a memory and a processor;

the memory is configured to store computer program instructions; and

the processor is configured to execute the computer program instructions to cause the electronic device to implement the method according to any one of the first aspects.

In a fourth aspect, the present disclosure provides a readable storage medium, including: computer program instructions; when the computer program instructions are executed by at least one processor of an electronic device, the computer program instructions cause the electronic device to implement the method according to any one of the first aspects.

In a fifth aspect, the present disclosure provides a computer program product, including: computer program instructions; the computer program instructions being stored in a readable storage medium, at least one processor of an electronic device reading the computer program instructions from the readable storage medium, and the at least one processor executing the computer program instructions to cause the electronic device to implement the method according to any one of the first aspects.

The present disclosure provides an image processing method, an image processing apparatus, an electronic device, and a computer-readable storage medium. By acquiring an image to be processed containing jaggies and performing a one-dimensional blur processing on the image to be processed in a target direction, to the method realizes anti-aliasing of the image and improves the visual effect of the image. In addition, the present disclosure realizes anti-aliasing through one-dimensional blur processing, which can effectively reduce the time complexity of blur processing and improve processing efficiency. Moreover, in the present disclosure, the target direction corresponding to one-dimensional blur processing has an association relationship with a shape of the jaggies, which effectively ensures the anti-aliasing effect of the image on the basis of reducing the time complexity.

### BRIEF DESCRIPTION OF THE DRAWINGS

The accompanying drawings herein are incorporated into and form a part of the specification, illustrate embodiments consistent with the present disclosure, and are used in conjunction with the specification to explain the principles of the present disclosure.

In order to more clearly illustrate the technical solutions in the embodiments or prior art of the present disclosure, the following will briefly introduce the accompanying drawings that need to be used in the description of the embodiments or prior art, and it will be obvious to a person of ordinary skill in the field that other attachments can be acquired on the basis of these attachments without creative laborious effort.

FIG. 1 is a flowchart of an image processing method provided by an embodiment of the present disclosure;

FIG. 2 is a schematic diagram of the positional relationship between the center pixel point and the surrounding pixel points provided by an embodiment of the present disclosure;

FIG. 3 is a flowchart of an image processing method provided by another embodiment of the present disclosure;

FIG. 4 is a flowchart of an image processing method provided by another embodiment of the present disclosure;

FIG. 5 is a flowchart of an image processing method provided by another embodiment of the present disclosure;

FIG. 6 is a structural schematic diagram of an image processing device provided by an embodiment of the present disclosure; and

FIG. 7 is a structural schematic diagram of an electronic device provided by another embodiment of the present disclosure.

### DETAILED DESCRIPTION

In order to understand the above objects, features and advantages of the present disclosure more clearly, the scheme of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein. Obviously, the embodiments in the specification are only part of the embodiments of the present disclosure, not all of them.

It should be noted that the “jaggies” referred to in the present disclosure indicates the presence of jaggies in the image.

Embodiments of the present disclosure provide an image processing method, an image processing apparatus, an electronic device, a computer-readable storage medium, and a computer program product. By acquiring an image to be processed containing jaggies and performing a one-dimensional blur processing on the image to be processed in a target direction, the method realizes anti-aliasing of the image and improves the visual effect of the image. In addition, the present disclosure realizes anti-aliasing through one-dimensional blur processing, which can effectively reduce the time complexity of blur processing and improve processing efficiency. Moreover, in the present disclosure, the target direction corresponding to one-dimensional blur processing has an association relationship with a shape of the jaggies, which effectively ensures the anti-aliasing effect of the image on the basis of reducing the time complexity.

The image processing method of the present disclosure can be executed by an electronic device. For example, the electronic device may include an internet of things (IOT) device, such as a tablet computer, a mobile phone (such as a folding screen mobile phone, a large screen mobile phone, etc.), a wearable device, a vehicle-mounted device, an augmented reality (AR)/a virtual reality (VR) device, a notebook computer, an ultra-mobile personal computer (UMPC), a netbook, a personal digital assistant (PDA), a smart TV, a smart screen, a high definition TV, a 4K TV. The present disclosure does not impose any limitations on the specific types of the electronic device.

The image processing method provided by the present disclosure is described in detail below by means of several specific embodiments, in combination with scenarios as well as the accompanying drawings. In the following embodiments, the electronic device is illustrated as an example.

FIG. 1 is a flowchart of an image processing method provided by an embodiment of the present disclosure. Referring to FIG. 1, the method of the embodiment includes:

S101, acquiring an image to be processed, the image to be processed including jaggies.

The electronic device can acquire the image to be processed.

The image to be processed can be acquired by the electronic device through image processing of the source image, for example, the blur processing, the enlarge processing and the like. Alternatively, the image to be processed can also be a source image including jaggies, that is, the image to be processed has not undergone any image processing, for example, the image to be processed is an image including jaggies shot by the electronic device. The present disclosure does not limit the cause of the jaggies included in the image to be processed, and the jaggies can be generated in any way.

For example, the method provided by the embodiment of the present disclosure may be applied to a static image processing scenario or a multimedia resource real-time processing scenario. Accordingly, the above-mentioned images to be processed may be a static image, such as a photo, a picture, etc. stored in the electronic device. Alternatively, the image to be processed may also be a video frame.

Assuming that the image to be processed is acquired by blurring the source image, for example, the image to be processed can be acquired by the following implementation:

the source image is reduced to a target scale to acquire a first image; next, the first image is subjected to a one-dimensional Gaussian blur processing in a first direction to acquire a processing result; on a basis of the processing result, the one-dimensional Gaussian blur processing in a second direction is executed to acquire a second image; then the second image is enlarged according to the scale of the source image, so as to acquire the image to be processed.

If the first direction is horizontal, the second direction is vertical; if the first direction is vertical, the second direction is horizontal.

In addition, a sampling step length corresponding to a horizontal one-dimensional Gaussian blur processing and a vertical one-dimensional Gaussian blur processing may or may not be equal. When the sampling step length corresponding to the horizontal one-dimensional Gaussian blur processing is equal to the sampling step length corresponding to the vertical one-dimensional Gaussian blur processing, the jaggies in the acquired image to be processed appears as a square; when the sampling step length corresponding to the horizontal one-dimensional Gaussian blur processing is not equal to the sampling step length corresponding to the vertical one-dimensional Gaussian blur processing, the jaggies in the acquired image to be processed appears as a rectangle.

In some embodiments, the target scale may be, for example, one-half, one-quarter, one-sixteenth, etc. According to the present disclosure, by setting the target scale smaller than the scale of the source image, amounts of pixels to be processed in Gaussian blur processing can be reduced, thereby reducing the time complexity of Gaussian blur processing.

In addition, by executing the one-dimensional Gaussian blur processing on the first image horizontally and vertically, the calculation amount of a first Gaussian blur can be greatly reduced, and the time complexity can be reduced from O(n2) to O(n). Although a rendering operation is added, the test shows that the time-consuming cost of operation is far greater than that of rendering, so the time cost can be effectively reduced by adopting the above method.

Of course, in practical application, the source image can be processed in other ways to acquire the image to be processed, and the present disclosure is not limited to the implementation of acquiring the image to be processed.

S102, performing a one-dimensional blur processing on the image to be processed in a target direction to acquire a target image, the target direction having an association relationship with a shape of the jaggies.

The target direction is the direction corresponding to the one-dimensional blur processing, and in case of the shape of the jaggies in the image to be processed being a right-angled parallelogram, the target direction is any diagonal direction of the right-angled parallelogram.

For example, assuming that the shape of the jaggies in the image to be processed is a square, the target direction can be a positive 45-degree-direction or a negative 45-degree-direction.

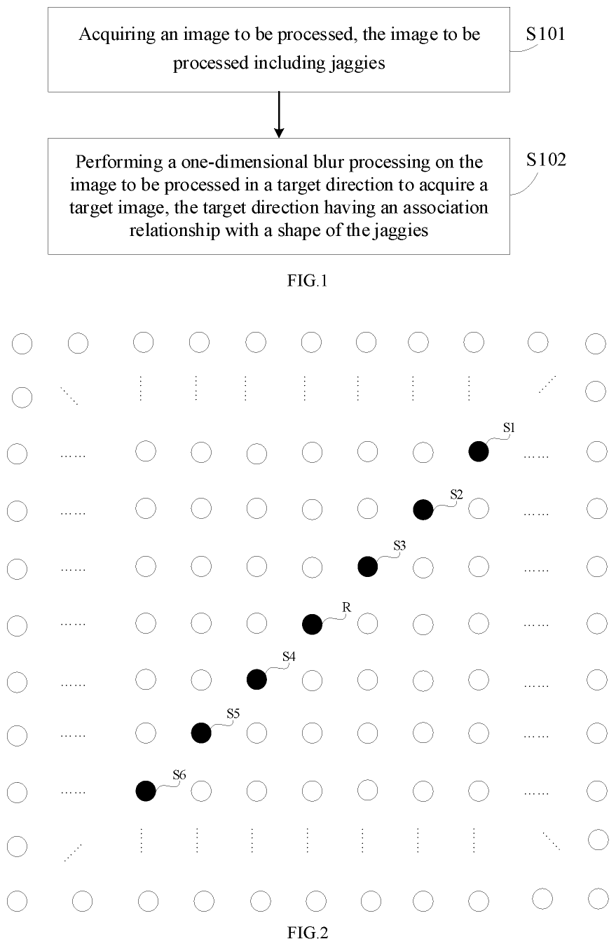

In FIG. 2, for example, the jaggies of the image to be processed is a square and the target direction is the positive 45-degree-direction, which explains the positional relationship between the center pixel point and the surrounding pixel points when the electronic device performs the one-dimensional Gaussian blur processing on the image to be processed. In the embodiment shown in FIG. 2, both a black solid circle and a white hollow circle represent the pixel points of the image to be processed, the pixel points represented by the black solid circle are the pixel points currently undergoing the one-dimensional blur processing.

For example, referring to FIG. 2, taking a target blur radius as 3 as an example, a positional relationship between a center pixel point R and pixel points S1 to S6 within the target blur radius and along the positive 45-degree direction is shown. Referring to FIG. 2, the connecting line between the center pixel point R and the surrounding pixel points S1 to S6 forms an included angle of 45 degrees with the horizontal direction or the vertical direction.

It should be understood that the pixel points S1 to S6 shown in the above-mentioned FIG. 2 are the surrounding pixel points for performing the one-dimensional blur processing. In practical application, the target blur radius can also be set to other values, for example, the target blur radius can be 4, 5, 6, etc., and a value of the target blur radius can be determined according to a desired blur, and the relationship between the desired blur and the value of the target blur radius can be proportional, which is not limited by the present disclosure.

In some embodiments, the one-dimensional blur processing in S102 can be any one of Gaussian blur, median blur and mean blur.

Next, the one-dimensional blur processing is divided into Gaussian blur, median blur and mean blur respectively, and combined with the situation shown in FIG. 2, it is introduced in detail in several different cases.

Case 1, the one-dimensional blur processing is the one-dimensional Gaussian blur processing, the jaggies in the image to be processed is a square, and the target direction is the positive 45-degree-direction.

For example, the image to be processed is subjected to the one-dimensional Gaussian blur processing in the positive 45-degree direction to acquire the target image, which can be acquired by any of the following implementations:

In some implementations, the following steps may be included:

Step a1, determining a center pixel point according to the target sampling step length corresponding to the one-dimensional Gaussian blur processing, and acquiring a pixel value of the center pixel point and pixel values of the surrounding pixel points corresponding to the center pixel point according to the target blur radius corresponding to the one-dimensional Gaussian blur processing.

For example, in combination with the situation shown in FIG. 2, if the pixel points S1 to S6 are all the surrounding pixel points of the center pixel point R, then the pixel values of the center pixel point R and the surrounding pixel points S1 to S6 are acquired.

Step a2, acquiring a value of a center pixel point in the target image by performing a weighting calculation according to the pixel value of the center pixel point, the pixel values of the surrounding pixel points, and a convolution kernel corresponding to the one-dimensional Gaussian blur processing. according.

The convolution kernel corresponding to the one-dimensional Gaussian blur processing can be acquired according to a gaussian curve calculation.

Steps a1 to a2 are repeatedly executed, that is, the position of the center pixel point is updated, and the pixel value of the updated center pixel point is acquired, and the steps are repeatedly executed until a pixel value of the last center pixel point is acquired, thereby acquiring the target image.

In other implementations, the following steps may be included:

Step b1, determining a center pixel point according to a target sampling step length corresponding to the one-dimensional Gaussian blur processing, and determining the surrounding pixel points corresponding to the center pixel point according to a preset threshold value.

Specifically, according to the amount relationship between the preset threshold value and each element in the convolution kernel corresponding to the one-dimensional Gaussian blur, the surrounding pixel points corresponding to the center pixel point are determined from candidate pixel points corresponding to the center pixel point. The candidate pixel points corresponding to the center pixel point are all pixels in the target direction within the target blur radius corresponding to the center pixel point.

For example, in combination with the situation shown in FIG. 2, the candidate pixel points include the pixel points S1 to S6, assuming that the pixel points S1 and S6 are determined not to meet the requirements according to the preset threshold value and the size of each element in the convolution kernel, the pixel points S2 to S5 are determined to be the surrounding pixel points corresponding to the center pixel point R.

Step b2, acquiring the pixel value of the center pixel point and the pixel values of the surrounding pixel points corresponding to the center pixel point.

Specifically, acquiring the pixel value of the center pixel point R and the pixel values of the surrounding pixel points S2 to S5.

Step b3, acquiring a value of a center pixel point in the target image by performing a weighting calculation according to the pixel value of the center pixel point, the pixel values of the surrounding pixel points, and a convolution kernel corresponding to the one-dimensional Gaussian blur processing.

Next, steps b1 to b3 are repeatedly executed, that is, the position of the center pixel point is updated, and the pixel value of the updated center pixel point is acquired, and the execution is repeated until the pixel value of the last center pixel point in the target image is acquired, thereby acquiring the target image.

The candidate pixels within the blur radius of the center pixel are screened by the preset threshold value, and the anti-aliasing effect is ensured by retaining the pixels with high weight values, and the similar points with low weight values are omitted to reduce the computational complexity of blur processing and improve the processing speed.

In some embodiments, the preset threshold value is equal to one sixty-fourth. And the present disclosure does not limit the size of the preset threshold value.

In Case 1, if the one-dimensional Gaussian blur processing is realized by using a GPU of the electronic device, sampling times and calculation times can be reduced by using a sampler characteristic of the GPU, that is, a linear interpolation characteristic of a texture sampling.

For example, the GPU can load two texture pixel values at one time, and return the interpolation result according to the sampled texture pixel values. In this way, the time-consuming cost is basically the same as the cost of sampling a texture pixel at a time. Therefore, the number of shader instructions can be halved by using the sampler characteristics of the GPU, that is, the amount of sampling instructions is reduced to half, and the amount of arithmetic instructions is slightly increased, thus improving the performance by two times.

Case 2, the one-dimensional blur processing is a one-dimensional median blur processing, and the jaggies in the image to be processed is a square, and the target direction is the positive 45-degree-direction.

For example, the image to be processed is subjected to the one-dimensional median blur processing in the positive 45-degree direction to acquire the target image, which can be acquired by any of the following implementations.

In some implementations, the following steps may be included:

Step c1, determining a center pixel point according to a sampling step length corresponding to the one-dimensional blur processing, and acquiring the pixel value of the center pixel point and the pixel value of the surrounding pixel points corresponding to the center pixel point.

For example, in combination with the situation shown in FIG. 2, if the pixel points S1 to S6 are all the surrounding pixel points of the center pixel point R, then the pixel values of the center pixel point R and the surrounding pixel points S1 to S6 are acquired.

Step c2, sorting the pixel values of the center pixel point R and the pixel values of the surrounding pixel points S1 to S6 to acquire a pixel value sequence, and taking a median value of the pixel value sequence as the pixel value of the center pixel point R.

Next, steps c1 to c2 are repeatedly executed, that is, the position of the center pixel point is updated, and the pixel value of the updated center pixel point is acquired, and the execution is repeated until the pixel value of the last center pixel point in the target image is acquired, thereby acquiring the target image.

In other implementations, the following steps may be included:

Step d1, determining a center pixel point according to the sampling step length corresponding to the one-dimensional blur processing, and determining the surrounding pixel points corresponding to the center pixel point according to the preset threshold value.

Specifically, according to the preset threshold value and the amount relationship of each element in the convolution kernel corresponding to the one-dimensional Gaussian blur, the surrounding pixel points corresponding to the center pixel point are determined. For example, in combination with the situation shown in FIG. 2, the pixel points S1 to S6 are all candidate pixel points, assuming that the pixel points S1 and S6 do not meet the requirements according to the preset threshold value and the size of each element in the convolution kernel, the pixel points S2 to S5 are determined to be the surrounding pixel points corresponding to the center pixel point R.

Step d2, acquiring the pixel value of the center pixel point and the pixel values of the surrounding pixel points corresponding to the center pixel point.

Specifically, the pixel value of the center pixel point R and the pixel values of the surrounding pixel points S2 to S5 are acquired.

Step d3, sorting the pixel values of the center pixel point R and the pixel values of the surrounding pixel points S2 to S5 to acquire a pixel value sequence, and taking the median value of the pixel value sequence as the pixel value of the center pixel point R.

Next, steps d1 to d3 are repeatedly executed, that is, the position of the center pixel point is updated, and the pixel value of the updated center pixel point is acquired, and the execution is repeated until the pixel value of the last center pixel point in the target image is acquired, thereby acquiring the target image.

Case 3, the one-dimensional blur processing is a one-dimensional mean blur processing, and the jaggies in the image to be processed is a square, and the target direction is the positive 45-degree-direction.

In some implementations, the following steps may be included:

Step e1, determining the center pixel point according to the sampling step length corresponding to the one-dimensional Gaussian blur processing, and acquiring the pixel value of the center pixel point and the pixel value of the surrounding pixel points corresponding to the center pixel point.

For example, in combination with the situation shown in FIG. 2, if the pixel points S1 to S6 are all the surrounding pixel points of the center pixel point R, then the pixel values of the center pixel point R and the surrounding pixel points S1 to S6 are acquired.

Step e2: Calculating an average pixel value according to the pixel value of the center pixel point R and the pixel values of the surrounding pixel points S1 to S6, and determine the average pixel value as the pixel value of the center pixel point R.

Next, return to steps e1 to e2, that is, update the position of the center pixel point and acquire the updated pixel value of the center pixel point, and repeat the execution until the pixel value of the last center pixel point in the target image is acquired, thereby acquiring the target image.

In other implementations, the following steps may be included:

Step f1, determining the center pixel point according to the sampling step length corresponding to one-dimensional blur processing, and determining the surrounding pixel points corresponding to the center pixel point according to a preset threshold value.

Specifically, according to the preset threshold value and the amount relationship of each element in the convolution kernel corresponding to the one-dimensional Gaussian blur, the surrounding pixel points corresponding to the center pixel point are determined.

For example, in combination with the situation shown in FIG. 2, the pixel points S1 to S6 are all candidate pixel points, assuming that the pixel points S1 and S6 are determined not to meet the requirements according to the preset threshold value and the size of each element in the convolution kernel, the pixel points S2 to S5 are determined to be the surrounding pixel points corresponding to the center pixel point R.

Step f2, acquiring the pixel value of the center pixel point and the pixel values of the surrounding pixel points corresponding to the center pixel point.

Specifically, the pixel value of the center pixel point R and the pixel values of the surrounding pixel points S2 to S5 are acquired.

Step f3, calculating the average pixel value according to the pixel value of the center pixel point R and the pixel values of the surrounding pixel points S1 to S6, and determining the average pixel value as the pixel value of the center pixel point R.

Next, steps f1 to f3 are repeatedly executed, that is, the position of the center pixel point is updated, and the pixel value of the updated center pixel point is acquired, and the execution is repeated until the pixel value of the last center pixel point in the target image is acquired, thereby acquiring the target image.

It should be noted that when the jaggies in the image to be processed appears as a square, the target direction can also be a negative 45-degree direction, which is similar to the above, and will not be described here for brevity.

If the one-dimensional mean blur processing is realized by using the GPU of the electronic device, the sampler characteristic of the GPU, that is, the linear interpolation characteristics of the texture sampling, can be used to reduce the sampling times and calculation times. This is similar to the first case. Please refer to the detailed description of the Case 1, which will not be repeated here for the sake of brevity.

In the method provided by the present embodiment, the image to be processed containing jaggies is acquired, and the image to be processed is subjected to the one-dimensional blur processing in the target direction, so as to realize anti-aliasing of the image and improve the visual effect of the image. In addition, in the present embodiment, the anti-aliasing is realized by the one-dimensional blur processing, which can effectively reduce the time complexity of blur processing and improve processing efficiency. Moreover, in the present embodiment, the target direction corresponding to the one-dimensional blur processing is associated with the shape represented by the jaggies, which effectively ensures the anti-aliasing effect of the image on the basis of reducing the time complexity.

Combined with the detailed introduction of Case 1, Case 2 and Case 3 in the embodiment shown in FIG. 1, it can be seen that the above three cases respectively involve the realization of determining the surrounding pixel points from the candidate pixel points by using the preset threshold value, that is, the preset threshold value can affect the amount of the surrounding pixel points, thus affecting the calculation amount of electronic device, so the preset threshold value is very important.

In some implementations, the preset threshold value is set to a specific value, which can be acquired statistically based on a large number of experimental results.

In some embodiments, the one-dimensional blur processing is the one-dimensional Gaussian blur processing, the one-dimensional median blur processing and the one-dimensional mean blur processing, respectively, which can correspond to the same or different specific values, and the present disclosure does not limit this.

In other implementations, the preset threshold value can be acquired according to weight values of the pixel values corresponding to the pixel points within the target blur radius and along the target direction.

For example, if the one-dimensional blur processing is the one-dimensional Gaussian blur processing, the amount of the preset threshold value can be acquired according to the gaussian curve. For example, as shown in FIG. 3, if the change of the gaussian curve is small, that is, a fluctuation of the gaussian curve is small and smooth, as shown in curve 1a in FIG. 3, the amount of the preset threshold value can be increased, as shown in FIG. 3, and the preset threshold value can be set as x1; if the gaussian curve changes greatly, that is, the fluctuation of the gaussian curve is greatly, as shown in curve 1b in FIG. 3, the amount of the preset threshold value can be reduced, as shown in FIG. 3, and the preset threshold value can be set as x2, the x1 is greater than the x2.

If the one-dimensional blur processing is the one-dimensional median blur processing or the one-dimensional mean blur processing, the weight values of the pixel values corresponding to the pixel points within the target blur radius and along the target direction can be preset, or they can be set flexibly in other ways, for example, the weight values of pixel points can be determined according to the similarity of colors expressed by adjacent pixel points in the target direction, which is not limited by the present disclosure.

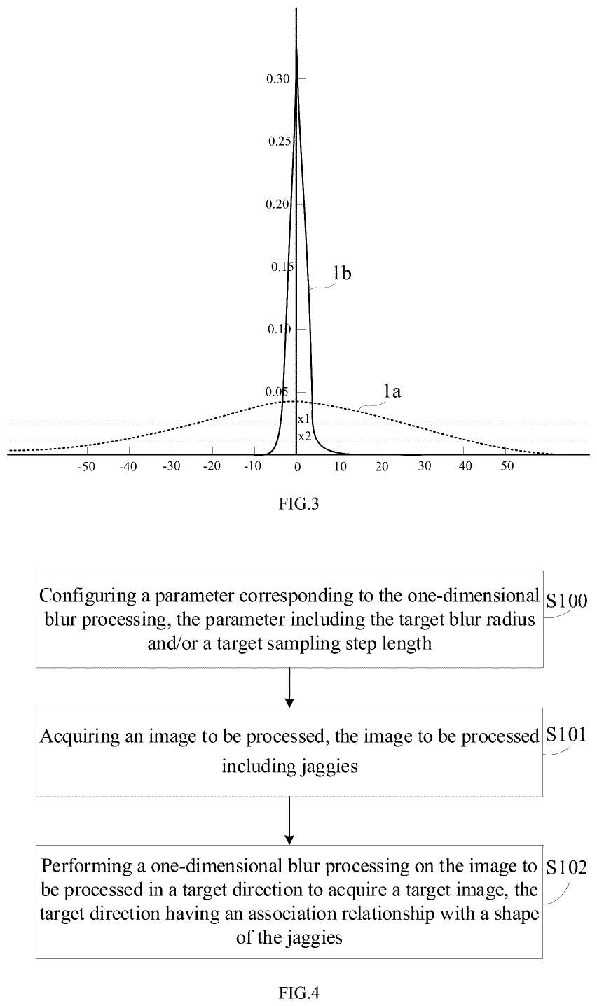

FIG. 4 is a flowchart of an image processing method provided by another embodiment of the present disclosure. On the basis of the embodiment shown in FIG. 1, before S102, it may further include:

S100, configuring a parameter corresponding to the one-dimensional blur processing according to a blur degree of the image to be processed, the parameter including the target blur radius and/or a target sampling step length.

Because the image to be processed includes jaggies, that is, the image to be processed already has a blur effect, when an image anti-aliasing is realized by the method provided by the present disclosure, the one-dimensional blur processing will increase a blur degree of the image, in order to flexibly meet the requirements of different users for the visual effect of the target image, in the embodiment, the electronic device can also provide an ability to configure the parameter of the one-dimensional blur processing in S102.

In some embodiments, the parameter of one-dimensional blur processing includes the target blur radius and/or the target sampling step length.

In some implementations, the electronic device can provide the user with different ambiguity options, when the user selects one of the blur degrees, the electronic device can determine the size of the parameters of one-dimensional blur processing according to the blur degree selected by the user.

For example, the electronic device provides users with 14 different blur degrees options from low to high, and each option corresponds to a corresponding blur coefficient; when the electronic device detects that the user has selected a certain blur option, the electronic device can determine the size of the corresponding one-dimensional blur processing parameter according to the blur coefficient corresponding to the blur option.

In some embodiments, a corresponding relationship between the blur coefficient and the size of the parameter of one-dimensional blur processing can be established in advance; and the electronic device can acquire the size of the parameter of one-dimensional blur processing by querying the corresponding relationship.

In other embodiments, a pre-configured parameter calculation formula can be used to substitute the blur coefficient into the parameter calculation formula to acquire the size of the one-dimensional blur processing parameter. The parameter calculation formula may include the calculation formula of the target blur radius and/or the calculation formula of target sampling step length. And the present disclosure does not limit the parameter calculation formula.

In other embodiments, the electronic device can also determine the blur coefficient corresponding to the one-dimensional blur processing according to the blur degree of the image to be processed before the one-dimensional blur processing. The electronic device acquires the parameter of one-dimensional blur processing according to the blur coefficient.

Assuming that the image to be processed is acquired by the Gaussian blur processing on the source image once, the blur of the image to be processed before the one-dimensional blur processing can be acquired by the sampling step length, a blur radius and other parameters of the Gaussian blur processing on the source image. If the image to be processed is acquired by processing the source image in other ways, the blur of the image to be processed can be determined by the corresponding parameter. Alternatively, the blur of the image to be processed can also be acquired through a pre-trained blur recognition model. The embodiment of the present disclosure does not limit the specific implementation of acquiring the blur of the image to be processed.

In practical application, in order to ensure the visual effect of the target image, if the blur of the image to be processed is high (that is, the image to be processed is blur), a blur requirement of the one-dimensional blur processing can be reduced (that is, the blur coefficient of the one-dimensional blur processing is low), for example, the target blur radius of the one-dimensional blur processing can be reduced and the target sampling step length of the one-dimensional blur processing can be increased. If the blur of the image to be processed is low (that is, the image to be processed is clear), the blur requirement of the one-dimensional blur processing can be increased, for example, the target blur radius of the one-dimensional blur processing can be increased and the target sampling step length of the one-dimensional blur processing can be reduced.

Alternatively, one-to-one correspondence between the blur degree of the image to be processed and the parameter of the one-dimensional blur processing can be pre-configured, and when the blur degree of the image to be processed is determined, the size of the parameter of the one-dimensional blur processing can be determined and configured by querying the pre-configured correspondence.

Alternatively, the corresponding relationship between the blur of the image to be processed and the parameters of multiple groups of the one-dimensional blur processing can be pre-configured, if the blur of the image to be processed is determined, any one of the parameters of multiple groups of the one-dimensional blur processing can be determined and configured by querying the pre-configured corresponding relationship.

S100 may be executed before S102 or S101.

In the embodiment, the target blur radius and/or the target sampling step length of the one-dimensional blur processing are configured by analyzing the requirements for the blur degree, so as to flexibly meet the requirements of different users for the visual effect of the target image. And in practical application, because the one-dimensional blur processing is needed to realize the image anti-aliasing, the blur requirement of the image to be processed can be reduced, that is, the blur requirement of the source image is reduced, thus reducing the corresponding calculation amount.

In a specific embodiment, referring to FIG. 5, it may include the following steps:

Step 1, creating two textures with a first resolution, which are respectively recorded as a Texture-A and a Texture-B; and creating an output texture with a second resolution, denoted as a Texture-C, and creating an FBO with the second resolution for rendering.

The FBO stands for Frame Buffer Object.

The first resolution is smaller than the second resolution, that is, the scales of the Texture-A and the Texture-B are smaller than that of the Texture-C. For example, resolutions of the Texture-A and the Texture-B may be one sixteenth, one eighth, one quarter of the resolution of the Texture-C, and so on.

The resolution of the Texture-C can be equal to that of a source image A.

Step 2, drawing the texture of the source image (the source image is denoted by A in FIG. 5) on one of the textures with the first resolution, for example, binding the Texture-B with the FBO, and then drawing the texture of the source image A on the Texture-B; the Texture-b is unbound from the FBO.

Step 3, binding the Texture-A with the FBO, performing a transverse one-dimensional Gaussian blur processing on texture B, and drawing the acquired processing result on the Texture-A; the Texture-A is unbound from the FBO.

Step 4, binding Texture-B with the FBO, performing a longitudinal one-dimensional Gaussian blur processing on the Texture-A, and drawing the acquired processing result on the Texture-B; the Texture-B is unbound from the FBO.

Steps 3 and 4 are equivalent to blurring the source image for the first time in the previous embodiment to acquire the image to be processed.

Step 5, binding the Texture-C with the FBO, enlarge the Texture-B according to the resolution (i.e. the second resolution) of the source image A, and performing the one-dimensional blur processing with the first sampling rate on the enlarged texture (refer to the detailed introduction of the one-dimensional blur processing in S102 in the previous embodiment), and the direction is the positive 45-degree-direction (or the negative 45-degree-direction), so as to acquire the target image (the target image is denoted by B in FIG. 5), i.e. the Texture-C.

It should be noted that the specific implementation process of step 5 is similar to steps 1 to 4.

In this embodiment, in steps 3 and 4, the sampling step length of the horizontal one-dimensional Gaussian blur processing is equal to the sampling step length of the vertical one-dimensional Gaussian blur processing, so the Texture-B jaggies enlarged to the A-scale of the source image appears as a square.

As shown in FIG. 5, after the execution of step 4, there is already the jaggies in texture B, it can be understood that the jaggies in the image to be processed will be more obvious after enlarging the Texture-B; however, the texture of the target image acquired after the processing in step 5 is smoother, by comparison, it can be seen that the jaggies in the image to be processed can be effectively weakened and the visual effect of the target image can be improved by executing the one-dimensional Gaussian blur processing on the image to be processed containing jaggies. And the target direction corresponding to the one-dimensional Gaussian blur processing is related to the shape represented by the jaggies, which ensures that the jaggies is weakened and the calculation amount of the one-dimensional Gaussian blur processing in step 5 is effectively reduced.

It should be understood that in step 5, the one-dimensional blur processing can be any one of the one-dimensional Gaussian blur processing, the one-dimensional median blur processing and the one-dimensional mean blur processing. The specific implementation process can refer to the detailed description of the aforementioned embodiments, and will not be repeated here for the sake of brevity.

It should be noted that in FIG. 5, only the process of binding the Texture-A, the Texture-B and the Texture-C with the FBO is shown, and the process of unbinding is not shown, but there is an unbinding process in practical application.

For example, the present disclosure also provides an image processing apparatus.

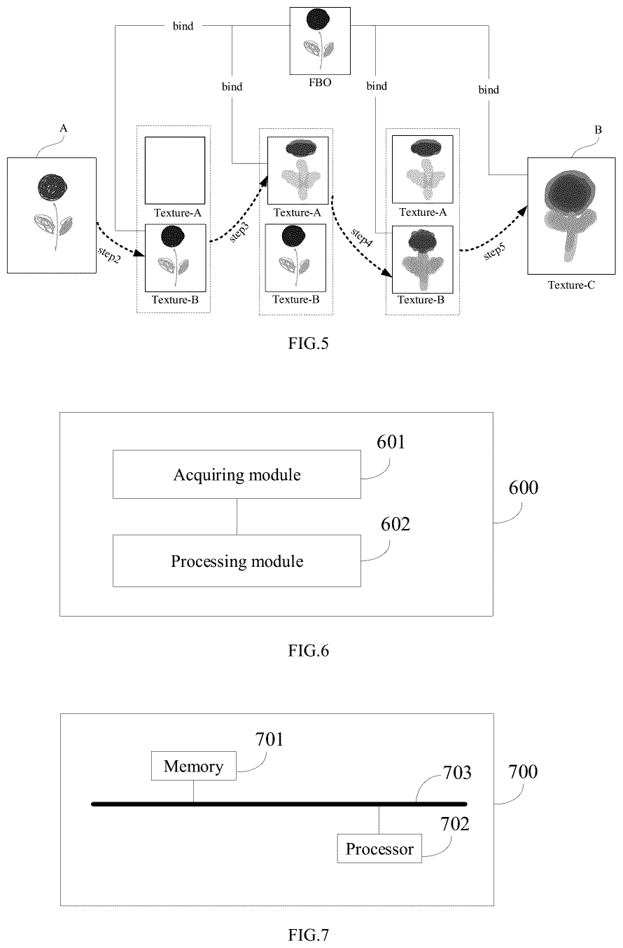

FIG. 6 is a schematic structural diagram of an image processing apparatus provided by an embodiment of the present disclosure. Referring to FIG. 6, an image processing apparatus 600 provided by this embodiment includes:

an acquiring module 601 is configured to acquire an image to be processed, the image to be processed including jaggies;

a processing module 602 is configured to perform a one-dimensional blur processing on the image to be processed in a target direction to acquire a target image, the target direction having an association relationship with a shape of the jaggies.

In some embodiments, if the shape of the jaggies in the image to be processed is a right-angled parallelogram, the target direction is any diagonal direction of the right-angled parallelogram.

In some embodiments, the processing module 602 is specifically configured to determine the center pixel point corresponding to each step of the blur processing according to the target sampling step length; acquire the pixel values of the center pixel point and the pixel values of the surrounding pixel points for each step of the blur processing, the surrounding pixel points including the pixel points along the target direction with the center pixel point as the center and within the target blur radius; acquire the value of the center pixel point in the target image by calculating according to the pixel value of the center pixel point, the pixel value of the surrounding pixel point and the convolution kernel corresponding to the one-dimensional blur processing.

In some embodiments, the processing module 602 is specifically configured to determine the pixel points along the target direction within the target blur radius with the center pixel point as the center as candidate pixel points for each center pixel point; determine the surrounding pixel points from the candidate pixel points according to the amount relationship between a preset threshold value and each element in the convolution kernel; acquire the pixel value of the center pixel point and the pixel values of the surrounding pixel points.

In some embodiments, the one-dimensional blur processing is any one of Gaussian blur, median blur and mean blur.

In some embodiments, the processing module 602 is further configured to determine parameters corresponding to the one-dimensional blur processing according to the blur degree of the image to be processed, the parameters including the target blur radius and/or the target sampling step length.

The processing module 602 can determine the parameters corresponding to the one-dimensional blur processing before the image to be processed is subjected to the one-dimensional blur processing in the target direction and the target image is acquired.

The image processing apparatus provided by this embodiment can be used to execute any of the above-mentioned method embodiments, and its implementation mode and technical effect are similar. Please refer to the description of the above-mentioned embodiment, and for the sake of brevity, it will not be repeated here.

FIG. 7 is a schematic structural diagram of an electronic device provided by an embodiment of the present disclosure. Referring to FIG. 7, an electronic device 700 provided by this embodiment includes a memory 701 and a processor 702.

The memory 701 may be an independent physical unit and can be connected with the processor 702 through a bus 703. The memory 701 and the processor 702 may also be integrated and implemented by hardware.

The memory 701 is configured to store program instructions, and the processor 702 calls the program instructions to execute the technical scheme of any of the above method embodiments.

In some embodiments, when part or all of the methods in the above embodiments are implemented by software, the above electronic device 700 may only include the processor 702. The memory 701 for storing programs is located outside the electronic device 700, and the processor 702 is connected with the memory through circuits/wires for reading and executing the programs stored in the memory.

The processor 702 may be a central processing unit (CPU), a network processor (NP) or a combination of the CPU and the NP.

The processor 702 may further include a hardware chip. The hardware chip can be an application-specific integrated circuit (ASIC), a programmable logic device (PLD) or a combination thereof. The PLD may be a complex programmable logic device (CPLD), a field-programmable gate array (FPGA), a generic array logic (GAL) or any combination thereof.

The memory 701 may include a volatile memory such as a random-access memory (RAM); the memory may also include a non-volatile memory, such as a flash memory, a hard disk drive (HDD) or a solid-state drive (SSD); The memory may also include a combination of the above kinds of memories.

The present disclosure also provides a readable storage medium, which includes computer program instructions, when the computer program instructions are executed by at least the processor of the electronic device, can realize the technical scheme of any of the above method embodiments.

The present disclosure also provides a computer program product, including computer program instructions, the computer program instructions being stored in a readable storage medium, at least one processor of an electronic device reading the computer program instructions from the readable storage medium, and the at least one processor executing the computer program instructions to cause the electronic device to implement the technical scheme as in any method embodiment.

It should be noted that in the present disclosure, relational terms such as “first” and “second” are only used to distinguish one entity or operation from another entity or operation, and do not necessarily require or imply that there is any such actual relationship or order between these entities or operations. Moreover, the terms “include/including”, “comprise/comprising” or any other variations thereof are intended to cover non-exclusive inclusion, so that a process, method, article, apparatus or device comprising a series of elements includes not only those elements, but also other elements not explicitly listed or elements inherent to such process, method, article, apparatus or device. Without further restrictions, an element defined by the phrase “comprises/includes a . . . ” does not exclude the existence of other identical elements in the process, method, article, apparatus or device comprising the element.

What has been described above is only the specific embodiment of the present disclosure, so that those skilled in the art can understand or realize the present disclosure. Many modifications to these embodiments will be obvious to those skilled in the art, and the general principles defined herein can be implemented in other embodiments without departing from the spirit or scope of this disclosure. Therefore, the present disclosure will not be limited to the embodiments described herein, but is to be accorded the widest scope consistent with the principles and novel features disclosed herein.

1. An image processing method, comprising:
acquiring an image to be processed, wherein the image to be processed comprises jaggies; and
performing a one-dimensional blur processing on the image to be processed in a target direction to acquire a target image, wherein the target direction has an association relationship with a shape of the jaggies.

2. The method according to claim 1, wherein, in case of the shape of the jaggies being a right-angled parallelogram, the target direction is any diagonal direction of the right-angled parallelogram.

3. The method according to claim 1, wherein, the performing the one-dimensional blur processing on the image to be processed in the target direction to acquire the target image, comprises:
determining a center pixel point corresponding to each step of the blur processing according to a target sampling step length;
acquiring a pixel value of the center pixel point and pixel values of surrounding pixel points for each step of the blur processing, wherein the surrounding pixel points comprise pixel points along the target direction within a target blur radius centered on the center pixel point; and
acquiring a value of a center pixel point in the target image by calculating according to the pixel value of the center pixel point, the pixel values of the surrounding pixel points, and a convolution kernel corresponding to the one-dimensional blur processing.

4. The method according to claim 3, wherein, the acquiring the pixel value of the center pixel point and the pixel values of surrounding pixel points for each step of the blur processing, comprises:
determining the pixel points along the target direction within the target blur radius centered on the center pixel point as candidate pixel points for each center pixel point;
determining the surrounding pixel points from the candidate pixel points according to an amount relationship between a preset threshold value and each element in the convolution kernel; and
acquiring the pixel value of the center pixel point and the pixel values of the surrounding pixel points.

5. The method according to claim 1, wherein the one-dimensional blur processing is any one selected from a group consisting of Gaussian blur, median blur and mean blur.

6. The method according to claim 1, wherein, before the performing the one-dimensional blur processing on the image to be processed in the target direction to acquire the target image, the method further comprises:
determining a parameter corresponding to the one-dimensional blur processing according to a blur degree of the image to be processed, wherein the parameter comprises a target blur radius and/or a target sampling step length.

7. An image processing apparatus, comprising:
an acquiring module configured to acquire an image to be processed, wherein the image to be processed comprises jaggies; and
a processing module configured to perform a one-dimensional blur processing on the image to be processed in a target direction to acquire a target image, wherein the target direction has an association relationship with a shape of the jaggies.

8. An electronic device, comprising: a memory, a processor, and computer program instructions,
wherein the memory is configured to store the computer program instructions; and
the processor is configured to execute the computer program instructions to cause the electronic device to implement an image processing method, and the method comprises:
acquiring an image to be processed, wherein the image to be processed comprises jaggies; and
performing a one-dimensional blur processing on the image to be processed in a target direction to acquire a target image, wherein the target direction has an association relationship with a shape of the jaggies.

9. A readable storage medium, comprising: computer program instructions,
wherein, upon the computer program instructions being executed by at least one processor of an electronic device, the computer program instructions cause the electronic device to implement the method according to claim 1.

10. A computer program product, comprising: computer program instructions, the computer program instructions being stored in a readable storage medium, at least one processor of an electronic device reading the computer program instructions from the readable storage medium, and the at least one processor executing the computer program instructions to cause the electronic device to implement the method according to claim 1.

11. The method according to claim 2, wherein the one-dimensional blur processing is any one selected from a group consisting of Gaussian blur, median blur and mean blur.

12. The method according to claim 3, wherein the one-dimensional blur processing is any one selected from a group consisting of Gaussian blur, median blur and mean blur.

13. The method according to claim 4, wherein the one-dimensional blur processing is any one selected from a group consisting of Gaussian blur, median blur and mean blur.

14. The apparatus according to claim 7, wherein, in case of the shape of the jaggies being a right-angled parallelogram, the target direction is any diagonal direction of the right-angled parallelogram.

15. The apparatus according to claim 7, wherein the processing module is further configured to:
determine a center pixel point corresponding to each step of the blur processing according to a target sampling step length;
acquire a pixel value of the center pixel point and pixel values of surrounding pixel points for each step of the blur processing, wherein the surrounding pixel points comprise pixel points along the target direction within a target blur radius centered on the center pixel point; and
acquire a value of a center pixel point in the target image by calculating according to the pixel value of the center pixel point, the pixel values of the surrounding pixel points, and a convolution kernel corresponding to the one-dimensional blur processing.

16. The apparatus according to claim 15, wherein the processing module is further configured to:
determine the pixel points along the target direction within the target blur radius centered on the center pixel point as candidate pixel points for each center pixel point;
determine the surrounding pixel points from the candidate pixel points according to an amount relationship between a preset threshold value and each element in the convolution kernel; and
acquire the pixel value of the center pixel point and the pixel values of the surrounding pixel points.

17. The apparatus according to claim 7, wherein the one-dimensional blur processing is any one selected from a group consisting of Gaussian blur, median blur and mean blur.

18. The apparatus according to claim 7, wherein the processing module is further configured to:
determine a parameter corresponding to the one-dimensional blur processing according to a blur degree of the image to be processed, wherein the parameter comprises a target blur radius and/or a target sampling step length.

19. The electronic device according to claim 8, wherein, in case of the shape of the jaggies being a right-angled parallelogram, the target direction is any diagonal direction of the right-angled parallelogram.

20. The electronic device according to claim 8, wherein, the performing the one-dimensional blur processing on the image to be processed in the target direction to acquire the target image, comprises:
determining a center pixel point corresponding to each step of the blur processing according to a target sampling step length;
acquiring a pixel value of the center pixel point and pixel values of surrounding pixel points for each step of the blur processing, wherein the surrounding pixel points comprise pixel points along the target direction within a target blur radius centered on the center pixel point; and
acquiring a value of a center pixel point in the target image by calculating according to the pixel value of the center pixel point, the pixel values of the surrounding pixel points, and a convolution kernel corresponding to the one-dimensional blur processing.
